(19) United States
(12) Patent Application Publication
(10) Pub. No.: US 2022/0292547 A1
(43) Pub. Date: Sep. 15, 2022

(54) SYSTEM AND METHOD FOR AUTOMATIC DISTRIBUTION OF REWARDS FOR USER CONTENT IN SOCIAL NETWORKS

(71) Applicants: Samuel Robert Peurifoy, New York, NY (US); Nicholas Samuel Mertes, Oglesby, IL (US); Christopher Robert Williams, Boulder, CO (US); John Edward Peurifoy, Hoboken, NJ (US)

(72) Inventors: Samuel Robert Peurifoy, New York, NY (US); Nicholas Samuel Mertes, Oglesby, IL (US); Christopher Robert Williams, Boulder, CO (US); John Edward Peurifoy, Hoboken, NJ (US)

(21) Appl. No.: 17/200,855

(22) Filed: Mar. 14, 2021

(51) Int. Cl. G06Q 30/02; H04L 12/58; G06Q 50/00; G06Q 20/06; G06Q 20/38; G06Q 50/18

(52) U.S. Cl. CPC G06Q 30/0274; H04L 51/32; G06Q 30/0201; G06Q 50/01; G06Q 30/0275; G06Q 30/0249; G06Q 30/0243; G06Q 20/0655; G06Q 30/0283; G06Q 20/389; G06Q 50/18

(57) ABSTRACT

A system and method for the automatic distribution of rewards for user content within social networks is provided. Content that is posted by users to social networks may display a qualifying product or service, as determined by the operator of the system and method. Such content is identified by software algorithms and evaluated for its marketing value. A quantity of that evaluated value is then paid out to the original user, either immediately or on a deferred basis, in the form of currency. The present invention provides for a novel method to compensate social media users for their unpaid labor they have performed by inadvertently advertising products and services, and thus represents a material benefit for a large segment of the population.

### CROSS-REFERENCE TO RELATED APPLICATIONS

No claims.

### TECHNICAL FIELD

Embodiments of the disclosure are generally related to allocating rewards to users of social networks based on content performance.

### BACKGROUND

Social media networks are online services with multiple users who may create content which is then distributed to other users. This content may take the form of text, imagery, videos, photos, files, moments, reactions, memes, or other formats.

This posted or shared content currently holds no monetary value for the generating user. The principal purpose of the posted or shared content is to propagate the social media network and drive more traffic to such network.

Marketing firms and advertisers have taken interest in the content generated on these online services, as certain users garner large amounts of attention from other users. These influential users, termed influencers, are often paid to post or share content that references or promotes a brand, product, or service. Interested marketing firms and advertisers seek to generate engagements, which take the form of reactions (“likes,” or others), shares, or comments.

The process of finding an appropriate influencer, describing to them a marketing campaign, vetting their content, completing promised payments, and maintaining the necessary relationships results in a sum of costs that lead to market inefficiencies. These costs are generally borne by the advertiser in the form of higher employee costs, due to the increased supervision required of the process.

Furthermore, the influencers that are usually targeted by the aforementioned advertising agencies are generally those influencers with a large (>10,000) number of followers, sometimes with potentially millions of users following their posted or shared content. This is because it is easy to manage the relationship with a single large influencer who may potentially reach thousands or millions of people with a single post, but there are significant drawbacks to using objectively “famous” influencers.

Engagement rates, as defined by the number of engagements divided by the total number of followers, are provably lower for high-follower accounts than they are for low-follower accounts. This leads to wasted capital, as the content or advertisements posted or shared do not reach as broad of an audience as may be implied by the large influencer's follower count, since fewer users engage with the content.

Furthermore, the impression a potential customer is left with may be one of inauthenticity, as they may not see themselves reflected well in the objectively more-famous influencer, and may interpret the posted or shared content or advertisement unfavorably as a marketing tactic.

However, on the opposite side of the influencer spectrum, everyday users boast provably higher engagement rates and likely demonstrate more authenticity with their smaller follower base. This is best captured by the well-known idiom “Keeping up with the Joneses,” wherein close neighbors tend to hold outsized influence over the decisions and behaviors of those proximal to themselves.

Low-follower accounts of everyday users are generally ignored for the purposes of posted or shared content advertisements, primarily due to the hassle involved with organizing a massive campaign by leveraging an unwieldy number of smaller relationships.

This represents a market inefficiency, as direct access to smaller influencers would permit higher return on investment due to higher engagement rates and likely higher authenticity.

### SUMMARY

In some implementations, a system tracks posted or shared content referencing a specific product, brand, or service. The posted or shared content is usually distributed through an established social media network, such as, but not limited to, Facebook®, Instagram®, or TikTok®.

In some implementations, a component evaluates the posted or shared content based on performance factors, demographics, and market data. These performance factors usually are, but are not limited to, “reactions,” “comments,” “likes,” “hearts,” or “shares.”

In some implementations, a component calculates the value of the posted or shared content using performance factors, demographics, and market data. This calculation may return a value in terms of currency, loyalty points, or a graded ranking.

A component automatically allocates rewards to the user based on the aforementioned value of the posted or shared. Such a component, either separate or in relation with the calculation component, automatically allocates rewards to the user in the form of fiat currencies, cryptocurrencies, loyalty points, gift cards, or products.

In some implementations, the rewards allocated may take the form of currencies, of either fiat or distributed blockchain in nature, or loyalty points, or products, or services. Distributed blockchain rewards may take the form of cryptocurrencies, such as Bitcoin or Ethereum, or may take the form of non-fungible tokens, which are to be understood as digital certificates, tokens, or codes that are in relation to the digital content posted by the user, as would be understood by one skilled in the art of blockchain operation and programming.

In some implementations, the automatic allocation of rewards may be deferred for either privacy of the user, or brand protection marketing purposes. In such a case, the implementation may then manually allocate the rewards to users. This manual allocation is accomplished by “accepting” a suggested payment by the system, or otherwise organizing a manual payment by way of financial transaction means common and known to those skilled in the art of online marketing or social media.

In some implementations, the posted or shared content may be associated with a “non-fungible token,” which may be distributed across a blockchain ledger. Such non-fungible tokens and their associated performance are then tracked by the system. These tokens may be explicitly linked to the digital content produced by the user, and may be owned by the user who creates the content, the advertiser or other entity interested in the distribution of the content, or the system described herein.

In some implementations, the posted or shared content may originate from the advertiser or other entity interested in the distribution of such content, and be provided to the user to be posted or shared. This content may take the form of images, text, videos, memes, stories, reactions, or any other form of content known to one of ordinary skill in the art of operating a social media account.

### BRIEF DESCRIPTION OF THE DRAWINGS

FIGS. 1A and 1B illustrate two examples of ways users could gain new monetary value from their posted or shared content.

FIG. 1C illustrates an example of the system architecture in accordance with an implementation. This figure outlines the modules which house the functions that may be used in accordance with an implementation.

FIG. 2 is a flowchart of a method in accordance with an implementation.

FIG. 3 is a flowchart of a method in accordance with an implementation.

FIG. 4 is a flowchart of a method in accordance with an implementation.

FIG. 5 is a flowchart of a method in accordance with an implementation.

FIG. 6 is a flowchart of a method in accordance with an implementation.

FIG. 7 is a flowchart of a method in accordance with an implementation.

FIG. 8 is a flowchart of a method in accordance with an implementation.

### DETAILED DESCRIPTION

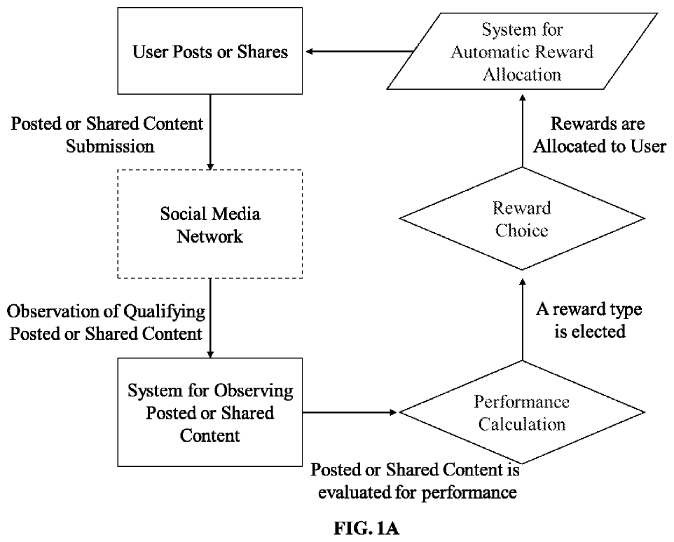

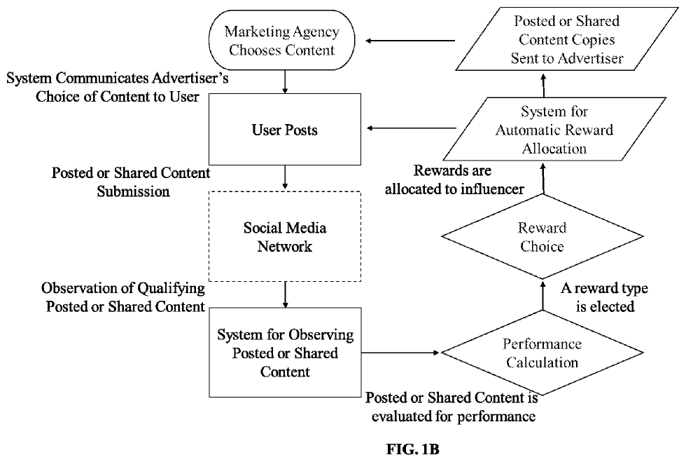

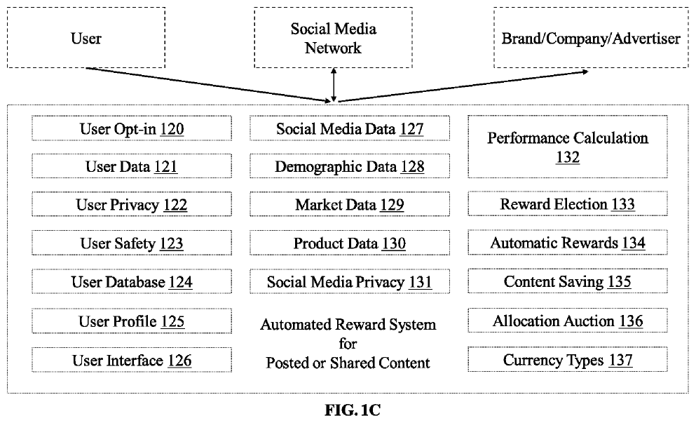

FIGS. 1A and 1B are two methodologies by which a system may track posted or shared content, and, subsequently, calculate the value of such content, in order to ultimately allocate rewards to the user. In FIG. 1A, a user posts or shares content to a social media network. This content is then observed by the system, which executes a performance calculation based on performance factors, including but not limited to, those such as “reactions,” “comments,” or “shares,” alongside demographic and market data of both the user and those who have engaged with the content. Optionally, the user may elect for a specific type of reward, which may include, but is not limited to, fiat currencies, cryptocurrencies, products, services, or loyalty points. The reward is then automatically allocated to the user, either by a mechanism included in the system itself or by signal to an external financial transaction system. In FIG. 1B, an alternate system methodology is shown, wherein a marketing agency or advertiser chooses a brand, product, or piece of content, which the system communicates to a user. The user subsequently posts or shares the content to a social media network, which is then observed by the system. The content is evaluated using a performance calculation as detailed above. The user may elect for a specific type of reward, by giving notice either through an interface function housed within a module of the system, a verbal agreement, or a written agreement. The reward is then automatically allocated to the user, either by a mechanism included in the system itself or by signal to an external financial transaction system. Copies of the posted or shared content are then sent to the original advertiser.

For example, a user who wished to engage with the system may opt-in to the system via website, app, verbal agreement, or written agreement. The user will then either post or share their own content, or be assigned content to be posted by an advertising agency or brand. The content, after being posted or shared, will be monitored by the system, either immediately or after some time delay. The content will then be evaluated based on performance factors, inclusive of but not limited to, factors such as the number of “reactions,” “comments,” or “shares,” as well as the demographic and market data available of the user and those users that have engaged with the content. The system will calculate a value for the content, and then automatically distribute a corresponding payment to the user. In some implementations, the system may also save copies of the content which will be forwarded to an advertising agency either immediately or upon some time delay.

An advertising agency, or other entity wishing to distribute or incentivize content creation or engagement, who wished to engage with the system may opt-in to the system via website, app, verbal agreement, or written agreement. The advertising agency or other entity may either request that some piece of content, as provided by the agency or entity, be posted or shared by the user, or, the agency or entity may request that the user generate their own content to share or post. The content will then be observed by the system as described above, and evaluated on factors as described above. The system will calculate a value for the content, and then automatically distribute a corresponding payment to the user. In some implementations, the system may also save copies of the content which will be forwarded to an advertising agency either immediately or upon some time delay. In some implementations, payment for the content may not be automatic due to the preferences of the user or the agency or other entity, and may be deferred for some time delay.

In FIG. 1C, components used in some implementations are described. Module 120 consists of a User Opt-In function, wherein an access token, or username-password combination, are passed to a website, app, or software bundle which validates the user and serves as a confirmation of the user's intent to use the system. Module 121 consists of the methods for the collection of User Data, which may take the form of access tokens, usernames, passwords, legal names, or other pertinent demographic or market data, but is not limited to these forms. Module 122 consists of the treatment of User Privacy, which may include functions to prevent the overt intrusion of personal user details, and other safety measures to prevent the inadvertent disclosure of or malevolent capture of User Data. Module 123 consists of the methods for User Safety, which may take the form of documentation presented to the user to ensure their safe use of the system. Module 124 consists of the User Database, which may take the form of a hardware server or a cloud-based computing solution, but always includes the electronic or physical storage of the data and user decisions outlined in Modules 120-123. Module 125 houses the User Profile, which is the data that the user has control over and can change within the system, principally their username, interface preferences, and payment preferences. Module 126 consists of a user interface which the user will view upon entering an interface of the system, which in certain implementations may present the user with their current rewards to date, content shared or posted to date, and agreements with advertisers or other entities to date.

Additionally, in FIG. 1C, other components which may be further used in some implementations are described. Module 127 consists of functions to collect Social Media Data, which includes but is not limited to “reactions,” “comments,” or “shares.” Module 128 consists of functions to collect Demographic Data, which may include but is not limited to, ethnicity, race, location, age, peer groups, and family structure. Module 129 consists of functions to collect Market Data, which may include but is not limited to, product pricing, product reach, total market aggregate value, and sentiment trends. Module 130 consists of functions to collect Product Data, which may include but is not limited to, the performance of the advertised product or content shown in the user's posts with respect to number of clicks, purchases, or views. Module 131 consists of functions to appropriately delete social media data after an appropriate time delay, in order to comply with extant or future legislation governing the holding of social media data.

Additionally, in FIG. 1C, other components further used in some implementations are described. Module 132 houses the functions associated with calculating the performance of a specific piece of posted or shared content, which incorporates any or all of the data collected by modules 127-130. Module 133 houses functions related to user elections during system operation, namely the election of reward type, which may be chosen from a non-exhaustive list of fiat currency, cryptocurrency, loyalty points, services, or products.

Additionally, in FIG. 1C, other components which may be further used in some implementations are described. Module 134 houses functions related to the automatic distribution of the rewards, which are either chosen prior by the system operator, or elected by the user during system operation. These functions may be programmed to incorporate a time delay or other manual delay function to permit the vetting of posts or other content for marketing and brand preservation purposes. Module 135 houses functions and databases related to the saving of content posted or shared by users in the normal operation of the system. These functions or databases are generally housed on cloud-computing solutions, but, in certain implementations, may also be housed in non-cloud connected hardware computing solutions.

Additionally, in FIG. 1C, other components further used in some implementations are described. Module 136 houses the auction functions related to the allocation methodology. In the case that an advertiser has set an upper bound on the maximum funding available for a specific marketing campaign, or an entity operating the system has determined that only a certain maximum of rewards should be distributed for some specified content, the allocation algorithm decides which users are paid out first. The allocation methodology may differ by implementation, but some implementations may utilize a graded function to rank-order qualifying content by performance factors and advertiser or entity preferences. The qualifying content of the highest value is then paid out from the budget first, before lowering-valued content. Module 137 houses functions related to the storage and routing of currency types or rewards, which may include, but are not limited to, fiat currencies, cryptocurrencies, loyalty points, products, or services. These functions may allocate rewards from stored bank accounts, exchange accounts, product warehouses, or service catalogs.

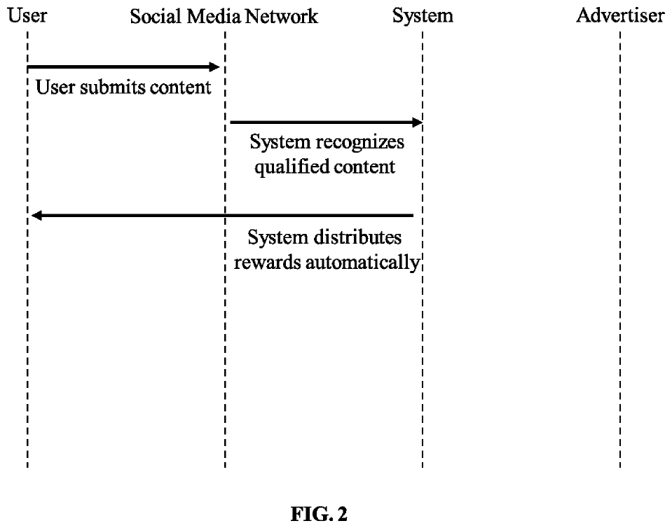

FIG. 2 demonstrates the most basic implementation of the system. Wherein, a user posts or shares content to a social media network, from which the content is subsequently observed by the system and evaluated based on performance factors, all of which is ultimately in order to distribute rewards automatically to the qualifying user.

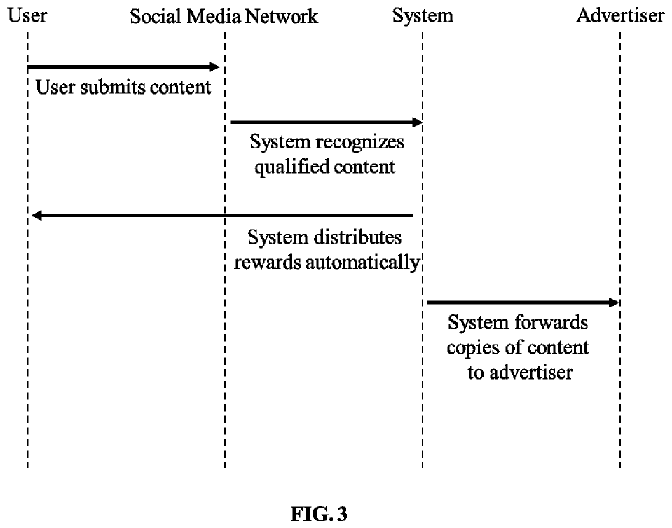

FIG. 3 demonstrates an implementation of the system comprising the same components as described in FIG. 2, with the sole addition of forwarding copies of the posted or shared content to an advertiser or other entity.

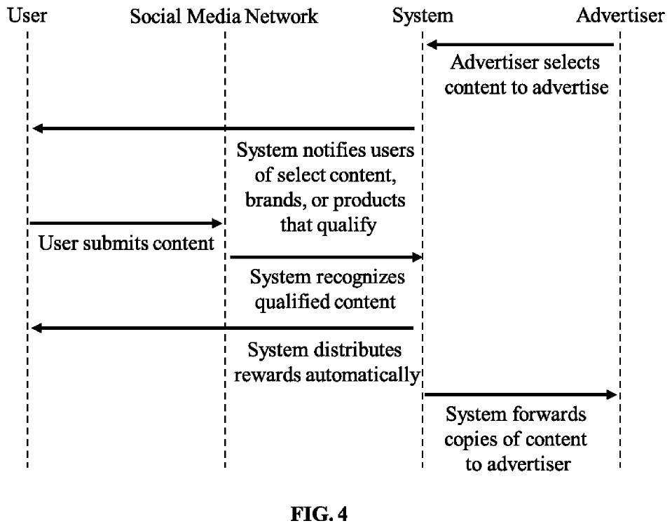

FIG. 4 demonstrates an implementation of the system wherein a method for the advertiser to select brands, products, or content to be posted or shared is the initial step. The system then notifies users of the advertiser- or entity-selected content, brands, or products that qualify for the system's performance evaluation methods. After submitting content, the system recognizes the qualified content and automatically distributes rewards to the users based on the performance metrics of the post, which have been assigned value by some valuation algorithm. Finally, the implementation forwards copies of the content that was posted or shared to the advertiser or other entity.

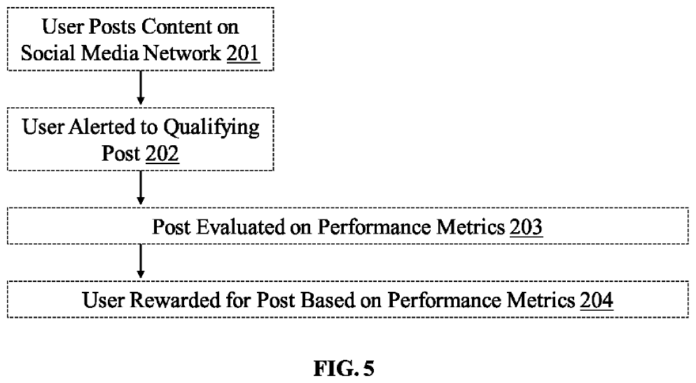

FIG. 5 demonstrates one such method flow for the software underlying the system described herein. Action 201 involves a user-initiated action of posting qualifying content to a social media network. Action 202 involves a system-initiated action of pushing a notification to the user who has posted or shared qualifying content, which, in some implementations, may be accompanied by a time delay to such notification. The notification, in some implementations, may take the form of, but is not limited to, banner notifications, email notifications, text messages, in-app alerts, phone calls, written communiques, or verbal messages. Action 203 involves invoking Module 132 to evaluate the output of Modules 127-130 and produce a valuation of the posted or shared qualifying content. Action 204 involves invoking Modules 133-137 to either automatically or manually disburse rewards to the user responsible for posting or sharing the qualifying content.

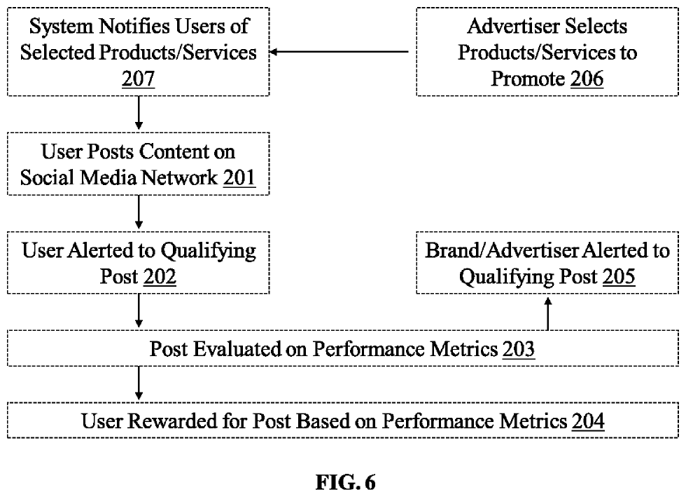

FIG. 6 comprises the components of FIG. 5 with the additions of actions related to an advertiser or other entity. Prior to the execution of Action 201, the method involves Action 206, in which an advertiser or other entity selects products, services, or content to promote or distribute, which, through the course of Action 207, is communicated to the users of the system via user interface functions and software housed in Modules 121-126. The content is then saved by invoking Module 134, and communicated to the advertiser or other entity by means common in the industry.

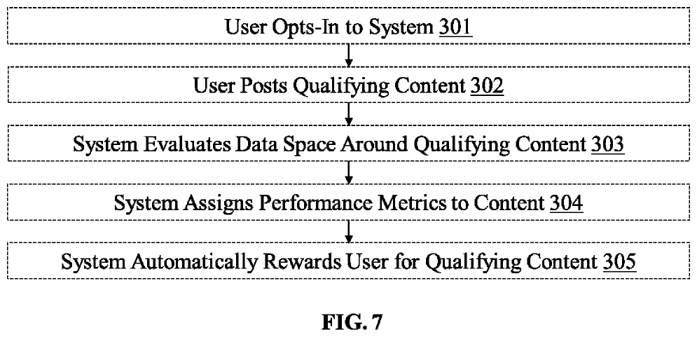

FIG. 7 describes a linear series of events comprising the usage of the system in some implementation. In a user-initiated sequence, the user opts-in to the system using Action 301, which invokes Module 120, followed by Modules 121-126. The user then posts content, Action 302, which invokes Module 127, in which social media dated is collected and parsed. This triggers Action 303, which invokes Modules 128-131, in which the system explores the auxiliary data space around the qualifying content, such as, but not limited to, demographic data, market data, and product data. This triggers Action 304, in which the system collates the parsed data and assigns performance metrics to the content in question by calling Module 132. The successful completion of Action 304 yields the initiation of Action 305, in which the system automatically rewards the user for qualifying content by calling Modules 133-137. This implementation of the system results in the automatic allocation of rewards to the user in response to their posting or sharing of qualifying content.

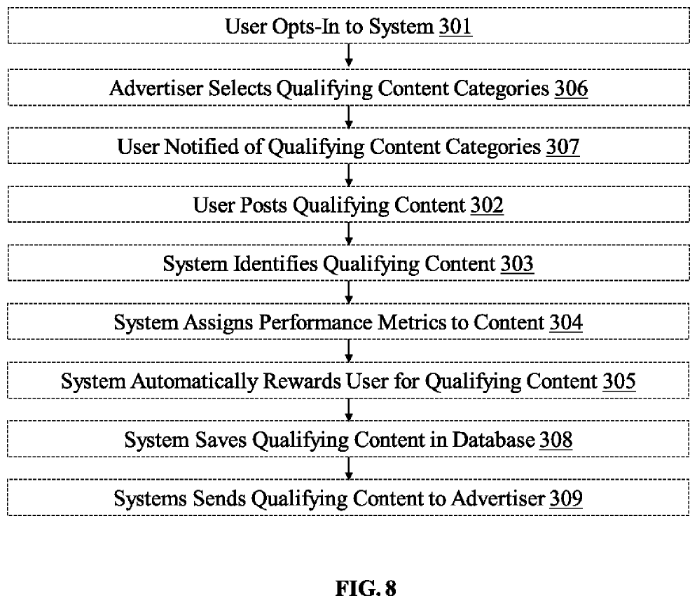

FIG. 8 describes a linear series of events comprising the components of FIG. 7, with the additions of actions related to an advertiser or other entity. After the execution of Action 301, in which the user opts-in to the system via processes housed in Module 120, an advertiser or other entity selects qualifying content or content categories during the course of Action 306. This triggers Action 307, in which a user is notified of the qualifying content or content categories by way of user interface functions housed in Modules 121-126, which may comprise, but are not limited to, app banner notifications, in-app notifications, email notifications, pop-up notifications, text messages, phone calls, physical communiques or verbal communications. In response to the functions executed in Action 307, Action 302 is triggered, in which a user posts qualifying content, which invokes Module 127, in which social media data is collected and parsed. This triggers Action 303, which invokes Modules 128-131, in which the system explores the auxiliary data space around the qualifying content, such as, but not limited to, demographic data, market data, and product data. This triggers Action 304, in which the system collates the parsed data and assigns performance metrics to the content in question by calling Module 132. The successful completion of Action 304 yields the initiation of Action 305, in which the system automatically rewards the user for qualifying content by calling Modules 133-137. This triggers Action 308, in which the system saves qualifying content in a database by calling functions housed in Module 135. The system then executes Action 309, in which the qualifying content is sent to an advertiser by means common to the industry, inclusive of, but not limited to, email, file repository, hardware or hard drive transfer, or distribution via blockchain networks.

### Usefulness and Advantages of the Invention

With respect to a one of ordinary skill in the relevant art of digital marketing, this invention represents a substantial step forward in streamlining the process of influencer marketing. This process provides a framework and some implementations for allocating rewards to users based on the performance of their social media content. A different but related process involving the manual recruitment and payment of influencers and users for content is the status quo known at the time of these disclosures, which is substantially different from the automatic system and methods described herein.

This invention also permits direct market access to an otherwise economically infeasible segment of social media users and influencers. Namely, this invention permits economic access to processing payments for and recruiting content from users of only a few thousand followers, or less. This is a market segment that is provably more efficient at influencing consumer decisions through peer advertising, and thus represents an attractive new entry point for innovation.

This invention utilizes only the minimum number of steps necessary to achieve the objective of automatically evaluating content and processing payments to users and established influencers of all follower ranks.

Furthermore, this invention empowers a new subsegment of social media users to gain significant economic advantage where they previously held none. Namely, as the content that a user posts can only be easily monetized in the current market if that user has a substantial number of followers and connections within the influencer industry, it is difficult for ordinary users or low-follower accounts to monetize their content. This invention directly addresses this market inequality by providing a direct route for payments and rewards to users of all ranks in exchange for their content.

This invention also allows for efficient capital allocation by rank-ordering the content resulting from user posts or shares via algorithms including but not limited to rank-order systems, weighted averages, or support vector machines.

Lastly, the integration of this invention with respect to non-fungible tokens represents a significant opportunity for both blockchain participants and traditional finance participants to exchange value in a frictionless environment, wherein the user can continue to gain economic value after the publishing of the digital content, and the advertiser gains economic value from streamlining of the process involved in the normal course of social media advertising.

### Alternate Embodiments and Implementations

The implementations described herein may be implemented as computer program instructions within another service or may be provided as an auxiliary service within a social media network. It is to be understood that such program instructions may be stored on non-transitory storage devices or media and, furthermore, may be executed by processors, which may be associated with network servers on either local area networks or cloud-based services.

References within this document around “some implementation.” “an implementation,” “one implementation,” or words of a similar understanding, should be understood to not necessarily refer to the same implementation. Furthermore, the particular characteristics described in connection with such implementations are to be understood as being included in at least one implementation of the description.

It is to be understood that throughout this document, references to “processing,” “calculating,” “computing,” “communicating,” “determining,” or similar words to that effect, refer to actions and processes of a related computer system or electronic device responsible for the computation and manipulation of related data.

The implementation described herein can be executed by way of software performed by a computer, or executed entirely by cloud software, or executed by a combination of hardware and software, either connected to a cloud or to a local area network.

The methods, algorithms, and implementations described herein are not necessarily related to any specific computer, electronic device, or other apparatus, and it may be more convenient to construct a specialized apparatus to perform the disclosures contained herein. A myriad of programming languages are viable candidates for implementing the specifications of the implementations contained within this document, including, but not limited to, Python, JavaScript, C++, HTML/CSS, and others.

The implementations described herein have been disclosed as examples for the purposes of illustration and education as to the operation of this invention. These are not intended to be all-encompassing or exhaustive, and it should be understood that many possible variations of the described implementations exist. These myriad variations are intended to be limited by the claims of this application, inasmuch that those variations do not depart from the spirit or essential characteristics of the invention disclosed within this application.

The computer programs, algorithms, and methods described within can each be implemented as either stand-alone programs, as components of a larger program, a number of smaller separate programs, as dynamic or static libraries, as kernel loadable modules, device drivers, or in any other way known now or in the future to those of ordinary skill in the art of programming.

For the purposes of interpreting the disclosures contained herein, “qualifying content” or “qualified content” may take the form of photos, videos, text, memes, non-fungible tokens related to digital media, or other methods of advertising known to one of ordinary skill in the art of digital marketing. The content should be understood to display a product, service, meme, idea, or brand, professional or personal, and is intended for the distribution to other users.

For the purposes of interpreting the disclosures contained herein, memes are broadly defined as images, photos, text, illustrations, videos, non-fungible tokens related to digital media, or other implementations of online content sharing known to one of ordinary skill in the art of sharing memes.

The auction allocation method mentioned in the disclosures herein comprises algorithmic components that dynamically determine the maximum value of some items of content. In some implementations, this is done by rank-ordering the posts by the value assigned to them using the functions housed within Module 132 to interpret and value the data obtained using functions housed within Modules 127-130. For example, if a series of users each submits content for which an advertiser has determined a maximum allowable budget, the user whose content accrues the highest value according to the valuation algorithm in the modules mentioned above would be the user who first receives the automatic payout via Module 134. In this way, advertiser budgets and the rewards due to users are auctioned starting with the highest value bidder. It is possible that users who post or share content that is deemed of low value by the algorithm do not receive a reward, if the maximum budget has been exceeded by the posting or sharing of higher value content.

For the purposes of interpreting the disclosures contained herein, non-fungible tokens are defined as cryptographic tokens residing on either a distributed blockchain ledger or a hardware wallet which provide for proof of authenticity of some underlying digital media. Non-fungible tokens in relation to the disclosures outlined herein, in some implementations, may be related to the qualifying content that the user posts or shares or the content that an advertiser or other entity provides to a user to post or share. The digital media related to the non-fungible token may take the form of images, photos, text, illustrations, videos, or other implementations of digital content known to one of ordinary skill in the art of navigating the internet.

Non-fungible tokens may be stored in any wallet application appropriate and known to one skilled in the art of blockchain systems, and such a wallet may include public and private keys relating to the access permissions of the token. It is understood that such non-fungible tokens may result from the issuance of smart contracts across decentralized blockchain networks, such as Ethereum, and would be transferrable by one skilled in the art of blockchain operation.

A user and an influencer are to be understood similarly in the context of this document. An influencer is a user with one or more fans or followers on a social media network. A user is any person who uses a social media network.

A module is to be defined as any block of code, computer program, electronic signal, or set of programming components in any programming language, any of which would be known to one skilled in the art of computer programming. An action is broadly defined to encompass any command, physical, electronic, or verbal, or set of commands performed by a user, program, machine, entity, or company in the course of some implementation.

The specifications outlined here are intended to be principally illustrative, but not limiting of, the implementation of the invention set forth in the following claims.

What is claimed is:

1. A method for providing a service to a social media user having one or more followers or fans, or to an advertiser or other entity interested in the promotion or distribution of content, or to a social media network, comprising:
tracking content posted or shared by a social media user;
valuing the content posted or shared by a social media user based on performance factors or demographic data;
and automatically allocating a reward to a social media user in response to the content posted or shared.

2. The method of claim 1, further comprising an auction-based reward allocation system for the determination of payouts when multiple users have submitted content that exceeds a budgetary maximum set by an advertiser or other entity interested in the distribution or promotion of content.

3. The method of claim 1, further comprising payment incentive notifications being sent to a user prior to the posting or sharing of qualified content, with the intention of incentivizing a user to create the qualified content.

4. The method of claim 1, further comprising a method for assigning value to content, and subsequently distributing that value, in the form of either fiat currency or cryptocurrency, to a social media user.

5. The method of claim 1, further comprising a method for assigning value to social media content, which is then mapped to and associated with a non-fungible token, which is then distributed upon a blockchain network.

6. The method of claim 1, further comprising a method for arranging contractual obligations with a social media user to post some aggregate value of posts over some period of time.

7. A method for providing a service to a social media user having one or more followers or fans, or to an advertiser or other entity interested in the promotion or distribution of content, or to a social media network, comprising:
valuing the content posted or shared by the social media user based on performance factors or demographic data;
and automatically allocating a reward to the social media user in response to the content posted or shared.

8. The method of claim 7, further comprising an auction-based reward allocation system for the determination of payouts when multiple users have submitted content that exceeds a budgetary maximum set by an advertiser or other entity interested in the distribution or promotion of content.

9. The method of claim 7, further comprising payment incentive notifications being sent to the user prior to the posting or sharing of qualified content, with the intention of incentivizing the user to create the qualified content.

10. The method of claim 7, further comprising a method for assigning value to content, and subsequently distributing that value, in the form of either fiat currency or cryptocurrency, to a social media user.

11. The method of claim 7, further comprising a method for assigning value to social media content, which is then mapped to and associated with a non-fungible token, which is then distributed upon a blockchain network.

12. The method of claim 7, further comprising a method for arranging contractual obligations with a social media user to post some aggregate value of posts over some period of time.

13. A method for providing a service to a social media user having one or more followers or fans, or to an advertiser or other entity interested in the promotion or distribution of content, or to a social media network, comprising:
automatically allocating a reward to the social media user in response to the content posted or shared.

14. The method of claim 13, further comprising an auction-based reward allocation system for the determination of payouts when multiple users have submitted content that exceeds a budgetary maximum set by an advertiser or other entity interested in the distribution or promotion of content.

15. The method of claim 13, further comprising payment incentive notifications being sent to the user prior to the posting or sharing of qualified content, with the intention of incentivizing the user to create the qualified content.

16. The method of claim 1, further comprising a method for assigning value to content, and subsequently distributing that value, in the form of either fiat currency or cryptocurrency, to a social media user.

17. The method of claim 13, further comprising a method for assigning value to social media content, which is then mapped to and associated with a non-fungible token, which is then distributed upon a blockchain network.

18. The method of claim 13, further comprising a method for arranging contractual obligations with a social media user to post some aggregate value of posts over some period of time.

19. The method of claim 13, further comprising a method for automatically forwarding the digital content to an advertiser or other entity interested in the distribution or promotion of such content.

20. The method of claim 13, further comprising a method for delaying the allocation of the reward, which either invokes some approval function or utilizes a simple time delay.
